(19) United States
(12) Patent Application Publication
(10) Pub. No.: US 2005/0017391 A1
(43) Pub. Date: Jan. 27, 2005

(54) Method for producing a thermoplastic resin molded article

(75) Inventors: Yoshitaka Kobayashi, Ichihara-shi (JP); Nobuhiro Usui, Ichihara-shi (JP)

Correspondence Address: FITCH, EVEN, TABIN & FLANNERY, P. O. BOX 65973, WASHINGTON, DC, 20035, US

(73) Assignee: Sumitomo Chemical Company, Limited, Osaka (JP)

(21) Appl. No.: 10/893,567

(22) Filed: Jul. 19, 2004

(30) Foreign Application Priority Data
Jul. 22, 2003 (JP) 2003-199652
Mar. 31, 2004 (JP) 2004-104340

(51) Int. Cl. B29C 44/14

(52) U.S. Cl. 264/46.4; 264/319

(57) ABSTRACT

Disclosed is a method for producing a thermoplastic resin molded article, the method comprising: providing a mold comprising paired female and male dies each having a cavity surface, the cavity surfaces being opposite each other, supplying a predetermined amount of thermoplastic resin in a molten state between the cavity surfaces, making the female and male dies approach relatively each other until a cavity having predetermined dimensions is formed by the cavity surfaces, wherein the relative approach of the female and male dies is started during or after the supply of the thermoplastic resin and is finished after the supply of the thermoplastic resin, and compressing the thermoplastic resin in the cavity via the female and male dies to fill a predetermined region of the cavity with the thermoplastic resin, wherein the mold closure speed is specially controlled.

### BACKGROUND OF THE INVENTION

1. Field of the Invention

The present invention relates to a method for producing a thermoplastic resin molded article.

2. Description of the Related Art

Thermoplastic resin molded articles are produced by various methods such as injection molding and compression molding. For example, U.S. Pat. No. 5,700,416 discloses a method in which a thermoplastic resin in a molten state is supplied between paired female and male dies in an open state and the dies are closed at a speed of 30 mm/sec or less, thereby a molded article is produced. Moreover, EP 0333198A2 discloses application of the foregoing method for the production of a multilayer molded article.

According to the method of the former document, a molded article which hardly occurs deformation and has a good appearance can be obtained. On the other hand, according to the method of the latter document, it is possible to obtain a multilayer molded article having a good appearance without damaging the feeling of a skin material.

Generally, in a production process of a thermoplastic resin molded article by compression molding or injection compression molding using a mold including a female and male dies, a thermoplastic resin in a molten state supplied between the female and male dies is spread between the cavity surfaces of the dies through the forced approach of the dies, namely so-called “mold closure”, and then, to the thermoplastic resin spread, a clamping force is applied by clamping the female and male dies, thereby the resin is distributed throughout a cavity, and the resin in a molten state is cooled to solidify. In general, the size of the molding machine used in the production of thermoplastic resin molded articles depends mainly on the clamping force required after mold closure. Therefore, the development of a molding method has been awaited which requires, after mold closure, a clamping force as small as possible.

### SUMMARY OF THE INVENTION

The object of the present invention is to provide a method for producing a thermoplastic resin molded article by compression molding, injection compression molding or the like using a mold including a female and male dies, the method requiring, after mold closure, a clamping force smaller than that necessary in conventional methods and, therefore, being able to contribute to size reduction of a molding machine required.

The present invention provides a method for producing a thermoplastic resin molded article, the method comprising: providing a mold comprising paired female and male dies each having a cavity surface, the cavity surfaces being opposite each other, supplying a predetermined amount of thermoplastic resin in a molten state between the cavity surfaces, making the female and male dies approach relatively each other until a cavity having predetermined dimensions is formed by the cavity surfaces, wherein the relative approach of the female and male dies is started during or after the supply of the thermoplastic resin and is finished after the supply of the thermoplastic resin, and compressing the thermoplastic resin in the cavity via the female and male dies to fill a predetermined region of the cavity with the thermoplastic resin, wherein when making the female and male dies approach relatively each other, a relative speed of the dies is increased to a maximum value Vmax and then is reduced from Vmax to zero, wherein Vmax is 30 mm/sec or more but 300 mm/sec or less, and wherein a deceleration during a period when the relative speed is reduced from 50% Vmax to 10% Vmax is 100 mm/sec² or more.

In one embodiment of the present invention, the female and male dies start to be moved relatively away from each other before or after the start of the supplying the thermoplastic resin in a molten state between the cavity surfaces.

In another embodiment of the present invention, during the compressing the thermoplastic resin, a maximum clamping pressure of from 0.5 MPa to 5 MPa is applied.

In another embodiment of the present invention, a skin material is supplied between the cavity surfaces before the start of the supplying the thermoplastic resin in a molten state, and the thermoplastic resin in a molten state is supplied while part or the whole of one of the cavity surfaces is covered with the skin material.

In another embodiment of the present invention, the cavity is composed of the predetermined region and a remainder region and an additional amount of thermoplastic resin in a molten state is supplied into the remainder region in the course of compressing the thermoplastic resin in the predetermined region.

In another embodiment of the present invention, the thermoplastic resin contains a foaming agent and wherein the method further comprises, after the compression, moving the female and male dies relatively away from each other until the distance between the cavity surfaces becomes a predetermined value, thereby expanding the inside of the thermoplastic resin in the cavity.

### BRIEF DESCRIPTION OF THE DRAWINGS

FIG. 1 is a perspective view showing one example of a thermoplastic resin molded article produced by the method of the present invention.

FIG. 2 is a perspective view showing another example of a thermoplastic resin molded article produced by the method of the present invention.

FIG. 3 is a sectional view showing one example of a mold to be used in the present invention.

FIG. 4 illustrates a state where a skin material has been supplied between a female and male dies.

FIG. 5 illustrates a state where a molten thermoplastic resin has been supplied between a female and male dies in execution of the method of the present invention. In this drawing, the molten thermoplastic resin is supplied between a skin material and a male die.

FIG. 6 illustrates a state where the mold closure has been completed in the execution of the method of the present invention.

FIG. 7 illustrates a state where a product is removed from a mold opened in the execution of the method of the present invention.

FIG. 8 illustrates a state where a foaming thermoplastic resin has been expanded in a cavity in the execution of the method of the present invention.

FIG. 9 is a schematic diagram showing one example of change of mold closure speed in the course of mold closure.

In the drawings, each of the reference numerals has a meaning shown below:
1: thermoplastic resin molded article, 2: skin material, 3: female die, 4: male die, 5: gate, 6: passage, 7: thermoplastic resin in a molten state, 8: foaming molten thermoplastic resin

### DESCRIPTION OF THE PREFERRED EMBODIMENTS

The method for producing a thermoplastic resin molded article of the present invention is a method comprising:
providing a mold comprising paired female and male dies each having a cavity surface, the cavity surfaces being opposite each other,
supplying a predetermined amount of thermoplastic resin in a molten state between the cavity surfaces,
making the female and male dies approach relatively each other until a cavity having predetermined dimensions is formed by the cavity surfaces, wherein the relative approach of the female and male dies is started during or after the supply of the thermoplastic resin and is finished after the supply of the thermoplastic resin, and
compressing the thermoplastic resin in the cavity via the female and male dies to fill a predetermined region of the cavity with the thermoplastic resin.

When the thermoplastic resin is being compressed via the female and male dies in the cavity, the temperatures of the dies are usually lower than the temperature of the thermoplastic resin. Therefore, the thermoplastic resin in the cavity is generally cooled during the compression.

In the following description, the expression “to close a mold” means “to make the female and male dies approach relatively each other.” On the other hand, the expression “to open a mold” means “to move the female and male dies relatively away from each other”. In addition, the “thermoplastic resin in a molten state” may also be also expressed as a “molten thermoplastic resin.”

Examples of the present invention will be described in detail below with reference to drawings, but the invention is not limited to the examples.

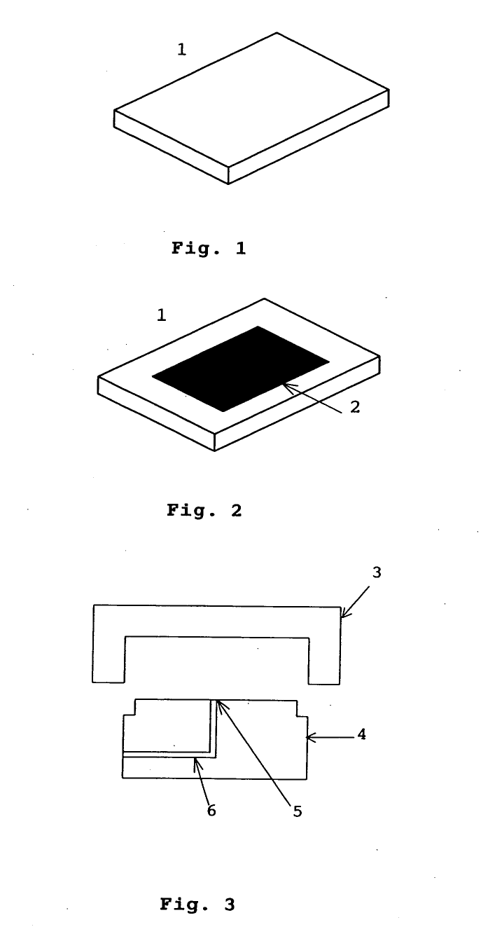

FIGS. 1 and 2 show examples of thermoplastic resin molded articles produced by the present invention. In the thermoplastic resin molded article shown in FIG. 2, a skin material (2) is integrated with a part of the surface of a thermoplastic resin substrate (1). Although, in this example, the skin material is integrated with only a part of the surface of the thermoplastic resin substrate, it may be integrated with the whole surface of the substrate. In addition, two or more skin materials may be integrated with part or the whole of the surface of the thermoplastic resin substrate. In the following, the cases where a skin material is used as shown in FIG. 2 are mainly explained, but the explanations can be applied also to the cases where no skin material is used unless otherwise described.

FIG. 3 is a cross-sectional view of one example of a mold to be used in the present invention. This mold includes paired opposite female die (3) and male die (4) each having a cavity surface, the cavity surfaces being opposite each other. The male die (4) is provided with a gate (5) for supplying molten thermoplastic resin therethrough. Thermoplastic resin in a molten state is supplied between the cavity surfaces through the gate (5) via a passage (6) formed in the male die (4). The location and the number of a gate or gates to be formed may be determined depending on the shape and the size of the molded article to be produced. When a skin material is integrated as shown in FIG. 2, it is desirable to form a gate (5) at a site where the skin material is integrated.

Regarding the paired female and male dies, in general, one of the dies is fixed on a stationary platen of a press unit (not shown) and the other die is fixed on a movable platen. The movable platen is moved toward the stationary platen by the action of a driving unit. Thus, the mold closure is carried out. The driving unit may be a hydraulic driving unit and an electric driving unit and the latter is preferably employed. It is desirable to use an electric driving unit because it is superior in responsiveness and is capable of controlling the mold closure speed precisely and of easily achieving a high speed.

Next, described is a method for producing the thermoplastic resin molded article shown in FIG. 2 using this mold.

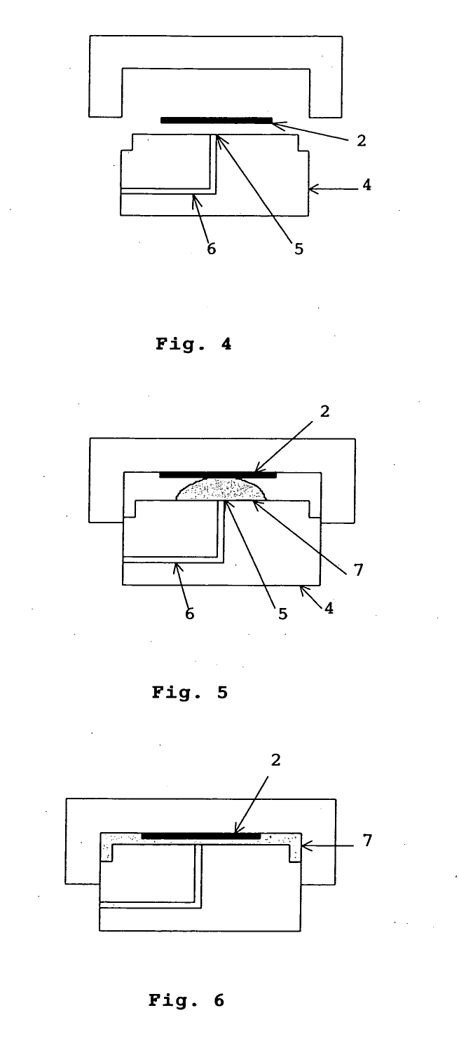

FIG. 4 shows a state where a skin material (2) has been supplied between the cavity surfaces of the female and male dies. The skin material (2) is preferably placed in such a manner that it covers a gate (5). The skin material (2) supplied between the dies may only be placed on the male die (4), but also may be fixed, by means of a pin or the like, to the male die (4) itself or female die (3) itself or a skin material fixing frame set up around the dies. Prior to the supply of the skin material between the female and male dies, the skin material may be preheated and/or preshaped depending on the desired product shape.

In the method of the present invention a predetermined amount of molten thermoplastic resin is supplied between the cavity surfaces of the female and male dies. FIG. 5 is a drawing which shows a state where molten thermoplastic resin (7) has been supplied between the skin material (2) and the male die (4) through the gate (5) via the passage (6). The cavity clearance of the female and male dies, in other words “the distance between the cavity surfaces in the mold closure direction”, at the time of supplying the molten thermoplastic resin may be determined appropriately depending upon the type of the skin material used and the shape and size of the product to be produced. If the cavity clearance at the start of the mold closure is too small, it is impossible to obtain a sufficient mold closure speed. Therefore, the cavity clearance (a: mm) at the start of the mold closure and the thickness (b: mm) of the product desirably satisfy a relation of (b+5)≦a, and more desirably (b+7)≦a.

When no skin material is used, it is desirable to adjust the cavity clearance at the start of the mold closure to (b+20) or less from the viewpoint of appearance of the molded article to be obtained. The cavity clearance at the start of the mold closure preferably is (b+5) or more.

In the method of the present invention, the female and male dies are made approach relatively each other until a cavity having predetermined dimensions is formed by the cavity surfaces. This operation is so-called “mold closure”. The forced relative approach of the female and male dies is started during or after the supply of the thermoplastic resin and is finished after the supply of the thermoplastic resin.

FIG. 6 is a drawing which shows a state where the mold closure has been finished. The molten thermoplastic resin supplied between the female and male dies is made flow between the cavity surfaces through the mold closure and is shaped into the shape of a cavity defined by the cavity surfaces. The timing of the start of the mold closure may be either during or after the supply of the thermoplastic resin. When the mold closure is started after the completion of the supply of the molten thermoplastic resin, it is desirable to start the mold closure immediately (usually within one second) after the completion of the supply of the thermoplastic resin.

In one preferred embodiment, the female and male dies start to be moved relatively away from each other before, at the same time, or after the start of the supply of the molten thermoplastic resin between the cavity surfaces and the dies start to be made approach relatively each other during or after the supply of the thermoplastic resin. For example, one is permitted to open the mold until the cavity clearance reaches a predetermined value while supplying molten thermoplastic resin between the female and male dies in a closed state and then close the mold. In this case, the supply of the molten thermoplastic resin may be started after the female and male dies start to be opened. Alternatively, the dies may start to be opened after the supply of the molten thermoplastic resin is started. It should be noted that the “closed state” means a state where a substantially closed cavity is defined by the cavity surfaces. The timing of the start of the mold closure may be either during or after the supply of the thermoplastic resin. When the mold closure is started after the completion of the supply of the molten thermoplastic resin, it is desirable to start the mold closure immediately (usually within one second) after the completion of the supply of the thermoplastic resin. The maximum value of the cavity clearance when the mold is opened while molten thermoplastic resin is supplied between the female and male dies in a closed state, preferably is b+50 (mm) or less for the case of integrating a skin material and b+20 (mm) or less for the case of integrating no skin material. Here, b has the same meaning as that defined above.

One is also permitted to supply, before the completion of mold closure, only a part of the molten thermoplastic resin required for forming a final product and, during the compression executed after the completion of the mold closure, supply the remaining molten thermoplastic resin into an unfilled space in the cavity. The amount of the molten thermoplastic resin to be supplied before the completion of the mold closure and the amount of the molten thermoplastic resin to be supplied after the completion of the mold closure may be adjusted depending on the proportions of the region to be formed from the resin supplied first and the region to be formed from the resin supplied later. The kind of the resin to be supplied first may be the same as or different from that of the resin to be supplied later. To separate the region to be formed from the resin supplied first and the region to be formed from the resin supplied later by means of a frame or the like will result in a more beautiful appearance of a molded article.

In any case, as shown in FIG. 9, when the female and male dies are made approach relatively each other, in other words, during the mold closure, the relative speed of the dies, in other words, the mold closure speed, is increased to a maximum value Vmax and then is reduced from Vmax to zero. In general, the acceleration and the deceleration are respectively carried out continuously. The time when the acceleration is completed and the time when the deceleration is started may be the same. Alternatively, a control pattern where after the mold closure speed reaches Vmax, the mold closure speed is maintained at Vmax for a predetermined period and then the mold closure speed is reduced, is also permitted. When the mold closure speed is maintained at Vmax for a predetermined period, the mold closure speed may vary slightly depending on the accuracy of the equipment used; However, the present invention includes embodiments where such a variation in mold closure speed occurs unless any special effect is exhibited by the variation. Vmax is 30 mm/sec or more but 300 mm/sec or less, and the deceleration during a period when the mold closure speed is reduced from 50% Vmax to 10% Vmax is 100 mm/sec² or more. The maximum value of the mold closure speed is preferably 40 mm/sec or more but 250 mm/sec or less, and more preferably 50 mm/sec or more but 200 mm/sec or less. The deceleration is preferably 150 mm/sec² or more, and more preferably 200 mm/sec² or more.

If the maximum value of the mold closure speed is too small, the mold clamping force required for completing the shaping of the molten thermoplastic resin spread in the cavity through the mold closure will become too large and a large mold clamping unit will be required. In addition, when the molten thermoplastic resin has a foaming ability, if the maximum value of the mold closure speed is too small, the gas accumulated in the molten resin will escape during the mold closure and, therefore, expanded molded articles having a good appearance and a desired expansion ratio may not be obtained. If the mold closure speed is too large, a large impactive force will act on the mold during the mold closure, resulting in breakage of the equipment or the mold.

The deceleration in a deceleration region extending from the start of reduction of the mold closure speed from Vmax to the completion of the mold closure may be varied. In the deceleration region, the deceleration during a period when the mold closure speed is reduced from 50% Vmax to 10% Vmax has a significant influence on the flow efficiency of resin by mold closure. The larger the deceleration during this period, the better the flow efficiency of resin by mold closure and the better the mold clamping force required for completing the shaping of the molten thermoplastic resin spread in the cavity through the mold closure can be reduced. The upper limit of the deceleration is not particularly restricted, but the deceleration is usually 1000 mm/sec or less. The deceleration during a period when the mold closure speed is reduced from 50% Vmax to 10% Vmax, D₅₀₋₁₀ (mm/sec²), is defined by the following formula:
D₅₀₋₁₀=(V₅₀−V₁₀)/(t₁₀−t₅₀)
wherein V₅₀ denotes a speed (mm/sec) which is 50% of Vmax, V₁₀ denotes a speed (mm/sec) which is 10% of Vmax, t₅₀ denotes a time (sec) when the mold closure speed reaches V₅₀, and t₁₀ denotes a time (sec) when the mold closure speed reaches V₁₀.

Although an example in which the mold is closed in the vertical direction is shown in FIGS. 3 to 6, the mold closure direction may be either vertical or horizontal.

In order to inhibit the occurrence of uneven luster between a portion formed during the supply of the molten thermoplastic resin and a portion formed after the completion of the supply of the molten thermoplastic resin but before the completion of mold closure, it is desirable that an average flow speed of the molten thermoplastic resin-during the supply of the molten thermoplastic resin, V1, and an average flow speed of the molten thermoplastic resin after the completion of the supply of the molten thermoplastic resin but before the completion of mold closure V2 satisfy a relation 0.5<V2/V1<5, more desirably 1<V2/V1<3.

The average flow speed of the molten thermoplastic resin during the supply of the molten thermoplastic resin, i.e. V1, is a value calculated from an average flow distance which the molten thermoplastic resin traveled during a period from the start of the supply of the molten thermoplastic resin to the completion of the supply, and the time during which the molten resin was supplied. The average flow distance is calculated from the cavity clearance at the completion of the supply of the molten thermoplastic resin and the amount of the molten thermoplastic resin supplied. The average flow speed V1 is usually from 10 mm/sec to 1000 mm/sec.

The average flow speed of the molten thermoplastic resin after the completion of the supply of the molten thermoplastic resin but before the completion of mold closure, i.e. V2, is a value calculated from an average flow distance which the molten thermoplastic resin traveled during a period from the completion of the supply of the molten thermoplastic resin to the completion of the mold closure, and a time from the completion of the supply of the molten thermoplastic resin to the completion of the mold closure. The average flow speed V2 is usually from 10 mm/sec to 500 mm/sec.

The average flow distances of the molten thermoplastic resin for use in the determinations of V1 and V2 each may differ depending on the flow directions according to the shape of a product even if the resin is supplied through a single gate. In such a case, an average of the longest travel distance and the shortest travel distance is used as an average flow distance.

In the case where there are two or more gates for supplying molten thermoplastic resin and through each gate approximately the same amount of resin is supplied, it is only required to determine an average flow speed of molten thermoplastic resin supplied through any one gate. When the amounts of resins supplied through the gates are significantly different from each other, it is only required that the average flow speed determined for the molten thermoplastic resin supplied through a gate through which the largest amount of resin is supplied be within the range mentioned above.

The mold is closed until a cavity having predetermined dimensions is formed and then the thermoplastic resin in the cavity is compressed via the female and male dies. Thus, a predetermined region of the cavity is filled with the thermoplastic resin. The “predetermined region of the cavity” may be either the entire cavity, or a part (not the whole) of the cavity. In the latter case, it is desirable that the cavity be separated by a frame or the like.

The maximum clamping pressure applied to the thermoplastic resin in the cavity during the compression is desirably from 0.5 MPa to 5 MPa, and more preferably from 0.5 MPa to 3 MPa. The maximum clamping pressure is a maximum value of clamping pressure obtained by dividing the clamping force by the projection area of the cavity of the mold viewed from the mold clamping direction. If the maximum clamping pressure is too small, it may be difficult to shape the molten thermoplastic resin into a desired shape. To apply a maximum clamping pressure over 5 MPa will require use of a large size of mold clamping unit.

The heat of the molten thermoplastic resin is taken away by the mold and, as a result, the molten thermoplastic resin in the cavity solidifies gradually from its surface.

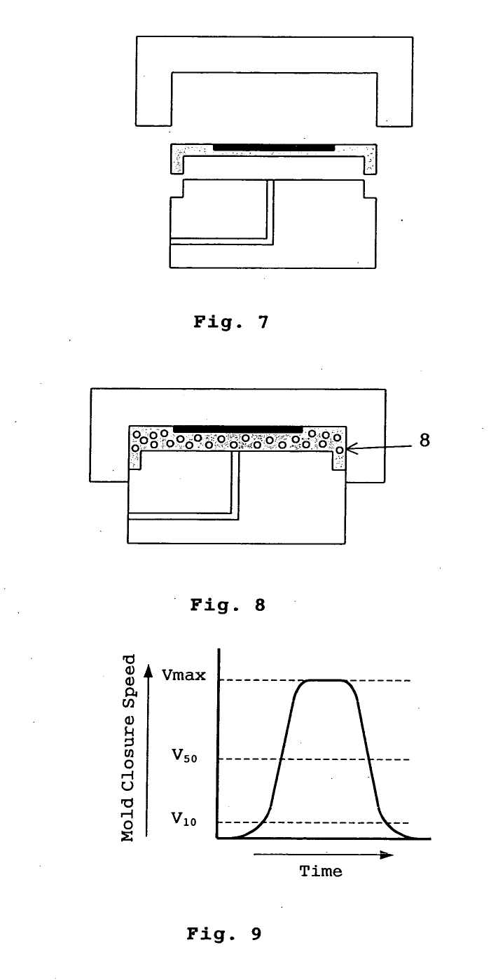

In the case where the thermoplastic resin used is a non-foaming thermoplastic resin, the female and male dies are opened and a molded article is removed as shown in FIG. 7 when the solidification of the thermoplastic resin has proceeded to a degree such that the resin will not deform even if the compression is released. Thus, a thermoplastic molded article integrated partially with a skin material such as that shown in FIG. 2 is obtained.

In the case where the thermoplastic resin used is a foaming thermoplastic resin containing a foaming agent, a primary cooling is carried out while the expansion of the thermoplastic resin in a cavity is inhibited. Thus, a substantially unexpanded skin layer is formed near the surface of the thermoplastic resin. The time of the primary cooling is ordinarily from about 0.1 sec to about 5 sec depending on the temperature of the mold, the temperature of the molten thermoplastic resin and properties of the thermoplastic resin such as melt viscosity.

When the cavity is enlarged along the thickness direction of the molded article (FIG. 8) after a skin layer having a predetermined thickness is formed, the gas forcedly contained in the thermoplastic resin still in a molten state which is located inside the skin layer (the central portion of the product) expands and cells are formed in the thermoplastic resin. Thus, the thermoplastic resin expands and a foamed layer is formed inside the skin layer. The enlargement of the cavity is stopped when the cavity clearance becomes a thickness of a desired product. The thermoplastic resin in the cavity is then cooled to solidify while that cavity clearance is maintained. The female and male dies are opened and a molded article is removed when the solidification of the thermoplastic resin has proceeded to a degree such that the resin will not deform even if the compression is released.

As the foaming agent for use in the present invention, known chemical foaming agents and known physical foaming agents used in the production of foamed articles of thermoplastic resin may be employed.

Examples of the chemical foaming agents include inorganic foaming agents such as sodium bicarbonate, ammonium bicarbonate and ammonium carbonate, nitroso compounds such as N,N′-dinitrosopentamethylenetetramine, azo compounds such as azodicarbonamide and azobisisobutyronitrile, sulfonylhydrazides such as benzenesulfonylhydrazide, toluenesulfonylhydrazide, diphenylsulfone-3,3′-disulfonylhydrazide, and p-toluenesulfonylsemicarbazide. To these chemical foaming agents, foaming aids such as salicylic acid and urea may be added.

Examples of the physical foaming agents include inert gas such as nitrogen and carbon dioxide, and volatile organic compounds other than freon-type organic compounds, such as butane and pentane.

The kind of the foaming agent may be appropriately determined with consideration given to the melting temperature of the thermoplastic resin to be used and the desired expansion ratio. The amount of the foaming agent added may be appropriately determined in view of the strength and density of the desired molded article. However, it is usually from 0.1 to 5 parts by weight for 100 parts by weight of the thermoplastic resin. In the case of using a physical foaming agent, a method in which a liquid or gaseous foaming agent is supplied into a molten thermoplastic resin under pressure.

In the present invention, thermoplastic resins ordinarily employed in compression molding, injection molding and extrusion forming may be employed. In the present invention, the thermoplastic resin includes thermoplastic resin, thermoplastic elastomer, mixtures thereof, and polymer alloys using them.

Examples of the thermoplastic resin include general thermoplastic resins such as polyamide, e.g. nylon, polypropylene, polyethylene, acrylonitrile-styrene-butadiene block copolymer, polystyrene, polyvinyl chloride, polycarbonate, acrylic resin and styrene-butadiene block copolymer, thermoplastic elastomer, mixtures thereof, and polymer alloys using them.

The thermoplastic resin may contain various kinds of additives such as glass fiber, inorganic filler, organic filler, pigment, lubricant, antistatic agent and stabilizer.

The skin materials used in the present invention include textiles and knitted webs such as moquette and tricot, nonwoven fabrics such as needle punch carpets, metal foils, and sheets and films of thermoplastic resins or thermoplastic elastomers.

The fibers constituting the nonwoven fabrics includes natural fibers such as cotton, hair, silk and hemp or synthetic resin fibers such as polyamine fiber, polyester fiber and nylon fiber. The nonwoven fabric may be constituted of either a single kind of fiber or two or more kinds of fiber. Moreover, the nonwoven fabric may be constituted of a mixture of natural fiber and synthetic fiber. The methods for producing the nonwoven fabric are classified into needle punching, thermal bonding, spun bonding, melt blowing or spun lacing. Nonwoven fabric produced by any method may be applied for the present invention.

The sheets and films of synthetic resin include those made of thermoplastic resins such as polypropylene and polyethylene or of polyolefin-based thermoplastic elastomers. Preferably employed are those which exhibit good weldability with the thermoplastic resin to be used as a substrate resin.

Such skin materials may be multilayer skin materials having a foam layer or a lining layer.

Examples of the foam layer include foams of polyolefins such as polypropylene and polyethylene, polyvinyl chloride foams, and soft or semi-rigid polyurethane foams.

The backing layer includes nonwoven fabrics and sheets and films of synthetic resin.

As a multilayer skin material, one having a good weldability with thermoplastic resin or one which can be bonded to a substrate resin through impregnation of its rear side with a molten thermoplastic resin is preferably employed from the viewpoint of bondability with a substrate made of thermoplastic resin.

The present invention will be described further by reference to an example and comparative examples, but the present invention is not limited to the example.

### EXAMPLE 1

Using a polypropylene (commercial name: Sumitomo Noblene AZ664E4, manufactured by Sumitomo Chemical Co., Ltd., MFR (210° C., 2.16 kgf) 30 g/10 min) as a thermoplastic resin, a 2.0-mm thick molded article having a projection area of 0.5 m² was molded. The mold used was a vertically clamping mold including a movable upper female die and a stationary lower male die. The mold clamping force of the mold clamping unit was 980 kN. While the cavity clearance was kept to 30 mm, a molten thermoplastic resin was supplied between the female and male dies. After the completion of the supply of the thermoplastic resin, the mold was closed and, after the completion of the mold closure, the thermoplastic resin was compressed at a clamping pressure of 2 MPa to yield a molded article. The maximum value of the mold closure speed, Vmax, was 70 mm/sec and the deceleration during a period when the mold closure speed was reduced from 50% Vmax to 10% Vmax was 330 mm/sec². The shape of the resulting molded article corresponded exactly to the shape of the cavity of the mold used.

### COMPARATIVE EXAMPLE 1

A molded article was obtained in the same manner as Example 1 except changing Vmax to 25 mm/sec and also changing the deceleration during the period when the mold closure speed was reduced from 50% Vmax to 10% Vmax to 120 mm/sec². The resulting molded article had a shape corresponding to that of the cavity of the mold used with some missing parts.

### COMPARATIVE EXAMPLE 2

A molded article was obtained in the same manner as Example 1 except changing Vmax to 30 mm/sec and also changing the deceleration during the period when the mold closure speed was reduced from 50% Vmax to 10% Vmax to 60 mm/sec². The resulting molded article had a shape corresponding to that of the cavity of the mold used with many missing parts.

TABLE 1

| | Vmax | Deceleration | |
|---|---|---|---|
| | (mm/sec) | (mm/sec²) | Shape of molded article |
| Example | 70 | 330 | Corresponding exactly |
| | | | to the cavity shape |
| Comparative | 25 | 120 | Missing some parts from |
| Example 1 | | | the cavity shape |
| Comparative | 30 | 60 | Missing many parts from |
| Example 2 | | | the cavity shape |

According to the present invention, by carrying out mold closure under specific conditions, the clamping force required after the mold closure is reduced in comparison to the case where mold closure is carried out under conventional conditions.

1. A method for producing a thermoplastic resin molded article, the method comprising:
providing a mold comprising paired opposite female and male dies each having a cavity surface, the cavity surfaces being opposite each other,
supplying a predetermined amount of thermoplastic resin in a molten state between the cavity surfaces,
making the female and male dies approach relatively each other until a cavity having predetermined dimensions is formed by the cavity surfaces, wherein the relative approach of the female and male dies is started during or after the supply of the thermoplastic resin and is finished after the supply of the thermoplastic resin, and
compressing the thermoplastic resin in the cavity via the female and male dies to fill a predetermined region of the cavity with the thermoplastic resin,
wherein when making the female and male dies approach relatively each other, a relative speed of the dies is increased to a maximum value Vmax and then is reduced from Vmax to zero, wherein Vmax is 30 mm/sec or more but 300 mm/sec or less, and wherein a deceleration during a period when the relative speed is reduced from 50% Vmax to 10% Vmax is 100 mm/sec² or more.

2. The method according to claim 1, wherein the method further comprises starting to move the female and male dies relatively away from each other before, at the same time, or after starting the supplying the thermoplastic resin in a molten state between the cavity surfaces.

3. The method according to claim 1 or 2, wherein during the compressing the thermoplastic resin, a maximum clamping pressure of from 0.5 MPa to 5 MPa is applied.

4. The method according to any one of claims 1 or 2, wherein the method further comprises supplying a skin material between the cavity surfaces before starting the supplying the thermoplastic resin in a molten state, and wherein the thermoplastic resin in a molten state is supplied while part or the whole of one of the cavity surfaces is covered with the skin material.

5. The method according to any one of claims 1 or 2, wherein the cavity is composed of the predetermined region and a remainder region, wherein, the method further comprises supplying an additional amount of thermoplastic resin in a molten state into the remainder region in the course of compressing the thermoplastic resin in the predetermined region.

6. The method according to any one of claims 1 or 2, wherein the thermoplastic resin contains a foaming agent and wherein the method further comprises, after the compression, moving the female and male dies relatively away from each other until the distance between the cavity surfaces becomes a predetermined value, thereby expanding the inside of the thermoplastic resin in the cavity.

7. The method according to claim 3, wherein the method further comprises supplying a skin material between the cavity surfaces before starting the supplying the thermoplastic resin in a molten state, and wherein the thermoplastic resin in a molten state is supplied while part or the whole of one of the cavity surfaces is covered with the skin material.

8. The method according to claim 4, wherein the cavity is composed of the predetermined region and a remainder region, wherein, the method further comprises supplying an additional amount of thermoplastic resin in a molten state into the remainder region in the course of compressing the thermoplastic resin in the predetermined region.

9. The method according to claim 5, wherein the thermoplastic resin contains a foaming agent and wherein the method further comprises, after the compression, moving the female and male dies relatively away from each other until the distance between the cavity surfaces becomes a predetermined value, thereby expanding the inside of the thermoplastic resin in the cavity.

10. The method according to claim 7, wherein the cavity is composed of the predetermined region and a remainder region, wherein, the method further comprises supplying an additional amount of thermoplastic resin in a molten state into the remainder region in the course of compressing the thermoplastic resin in the predetermined region.

11. The method according to claim 10, wherein the thermoplastic resin contains a foaming agent and wherein the method further comprises, after the compression, moving the female and male dies relatively away from each other until the distance between the cavity surfaces becomes a predetermined value, thereby expanding the inside of the thermoplastic resin in the cavity.
